(19) United States
(12) Patent Application Publication
(10) Pub. No.: US 2023/0182416 A1
(43) Pub. Date: Jun. 15, 2023

(54) PROCESS FOR MANUFACTURING A FIBRE-PLASTIC COMPOSITE

(71) Applicant: FIBIONIC GMBH, Thaur (AT)

(72) Inventors: Thomas RETTENWANDER, Thaur (AT); Johannes MANDLER, Thaur (AT)

(21) Appl. No.: 17/923,892

(22) PCT Filed: May 17, 2021
(86) PCT No.: PCT/AT2021/060171

§ 371 Date: Nov. 7, 2022

(30) Foreign Application Priority Data
May 18, 2020 (AT) A 50435/2020

(51) Int. Cl. B29C 70/54

(52) U.S. Cl. CPC B29C 70/543; B29C 70/541; B29C 70/548

(57) ABSTRACT

A process for manufacturing a fibre-plastic composite with a secured fibre orientation, wherein continuous fibres or long fibres are oriented and sheathed with a matrix, characterized by the steps of (a) providing a mold comprising at least one flow channel, (b) introducing the continuous fibres or long fibres into the at least one flow channel, (c) positioning and orienting the continuous fibres or long fibres in the at least one flow channel by way of a pressure gradient in the flow channel, (d) sheathing the continuous fibres or long fibres with a matrix.

The present invention relates to a process for manufacturing a fibre-plastic composite with continuous fibres or long fibres. Furthermore, the invention relates to a machining tool comprising a mold and at least one flow channel inserted into the mold.

### BACKGROUND OF THE INVENTION

Fibre-plastic composites with continuous or long fibres have very good mechanical properties. Notably because of the good ratios of strength and rigidity relative to density, those materials are perfect lightweight materials.

Since the production of such fibre-plastic composites with continuous or long fibres is complex and time-consuming and the fibres used are usually expensive, they are currently used predominantly only in the high-tech sector.

The mechanical behaviour of fibre composite materials is directional, with the mechanical properties, by their nature, being greatest in the fibre direction. Substantially worse properties arise in case of a deviation from this fibre direction.

In conventional manufacturing processes, the continuous or long fibres are placed in the component with a fixed fibre angle. Since stress conditions in complex components are multiaxial and the properties of the fibres are directional, composite materials are made up of several different layers with different fibre angles, which is referred to as a “constant stiffness design”. In consequence, however, the fibre-specific properties are not fully utilized.

More recent manufacturing processes aim to avoid those disadvantages by specifically orienting the fibres in the load direction (“variable stiffness design”). With such manufacturing processes, fibres can be curved and are no longer forced to be present in a straight fashion in components. The consequence of such a load-related orientation of the fibres is that far fewer fibres have to be used to achieve the same material properties in the load direction, whereby mass and costs can be saved.

Manufacturing processes for fibre-plastic composites with continuous or long fibres with the fibres having a specific orientation in the load direction are known and are also already being used in the industry. The so-called Tailored Fibre Placement applies individual fibre strands to a substrate using an embroidery technique. Any fibre orientation is thus possible. The Tailored Patch Placement deposits fibre cuts on a substrate with the help of a robot. Due to the process, the fibres are no longer continuous, but can also be placed in complex orientations. In addition to these processes, there are others that deposit fibres, usually with the help of robots, according to a load flow or according to some other design criterion. These processes are characterized by maximum material efficiency and minimal waste. However, the production of such structures is very time-consuming, and it is not possible to produce components for the mass market.

DE 10 2007 054 424 A1 describes a process for manufacturing a fibre-plastic composite, wherein fibres are blown into a mould. The fibre direction is determined via the blowing direction of a nozzle and can therefore be varied only within narrow limits.

In DE 10 2010 045 428 B4, a process for manufacturing a fibre-plastic composite is described in which fibres are transported to a processing location by means of an air stream. This transport takes place through a transport channel, wherein matrix resin is added during the transport of the fibres. Further processing and shaping is performed using conventional manufacturing methods.

EP 1 177 871 B1 describes fibre spraying whereby fibres are applied to an open tool mould using an undirected air stream. Exact positioning of fibres in the open tool is not possible.

DE 10 2016 103 979 A1 describes a process for producing a structural hollow member and the structural hollow member itself. The process is characterized in that a washable mould core is wrapped with fibres and, within a bore in this mould core, a strut is produced in the hollow member with fibres which are positioned by a needle or by an air stream.

Referring to manufacturing processes, the prior art known to date indeed basically shows the blowing of fibres into channels or generally into mould cavities; with this, however, only specific hollow members or, respectively, no components with a secured fibre orientation can be produced.

### BRIEF DESCRIPTION OF THE INVENTION

The processes used to date for the manufacture of fibre-reinforced plastics with a specific orientation of the fibres in the load direction are based on (temporally) costly placement concepts or injection methods that are geometrically imprecise and limited to one direction.

It is therefore the object of the present invention to provide a process for manufacturing fibre-reinforced plastics which allows the fibres to be oriented in a specific manner -possibly also with curvatures - in the load direction and enables short production times.

This object is achieved by a process for manufacturing a fibre-plastic composite with a secured fibre orientation, wherein continuous fibres or long fibres are oriented and sheathed with a matrix, characterized by the steps of
a) providing a mold (or forming tool) comprising at least one flow channel,
b) introducing the continuous fibres or long fibres into the at least one flow channel,
c) positioning the continuous fibres or long fibres in at least one flow channel by way of a pressure gradient in the flow channel, and
d) sheathing the continuous fibre or long fibre with a matrix.

Although a channel is described in DE 10 2010 045 428 B4, it only serves to provide and prepare a composite material, which can then be processed using conventional methods. The present invention uses the channels to allow precise positioning of fibres in a tool.

The tool-bound channels are responsible for fibre orientation. The exact position of the continuous fibres or long fibres in the subsequent fibre-plastic composite, which is usually a semi-finished product, is determined by the flow channels. The flow channels can run in a straight line, but they can preferably exist in any complex shape. Particularly preferably, the flow channels are curved at least once.

In one embodiment variant, it is envisaged that the continuous fibres or long fibres are positioned in the flow channel by a fluid stream.

The fluid stream for positioning the fibres is generated by a pressure gradient in the respective flow channel. This pressure gradient can be generated, for example, by a relative overpressure on the inflow side of the fluid or by a relative negative pressure on the outflow side of the fluid, or by both at the same time. The fluid is usually air but can also be an inert gas or noble gas. Similarly, evaporating liquids can also be used as a fluid. The fluid can be tempered or untempered.

In the simplest case, the continuous fibres or long fibres are simple rovings only made of reinforcing fibres. The continuous fibres or long fibres are preferably a hybrid roving (i.e., a roving made of reinforcing fibres and a matrix material), particularly preferably a commingled yarn (a roving made of reinforcing fibres and synthetic fibres as a matrix material).

The long fibres or continuous yarns consist either of pure continuous or, respectively, bound long fibres or of a composite of fibres and matrix, wherein the matrix can preferably exist in the form of polymer fibres, polymer powders or resins. Reinforcing fibres can include carbon, glass, aramid fibres, other polymeric, metallic and ceramic fibres as well as natural fibres.

As an alternative, long fibres or continuous yarns can also be introduced for other purposes. The long fibres or continuous yarns could, for example, fulfill decorative purposes. An alternative embodiment envisages that the long fibres or continuous yarns are introduced for thermal purposes. In these embodiments, the introduction of long fibres or continuous yarns is not only limited to the reinforcing effect. Of course, combinations of these functions are conceivable as well.

The mold usually has tool halves. The contact surface between the tool halves can constitute a flat surface or can be curved in a complex fashion. If the contact surface is a flat surface, semi-finished products are usually produced with the process, which are to be reshaped and sheathed with a matrix in a further step. If the reinforcement in a subsequent component is only two-dimensional, just a sheathing is required. If the contact surface is a curved surface, the degrees of deformation for a subsequent component can be reduced therewith, or the reinforcement geometry for the component could also be produced directly. In the latter case, just a sheathing is necessary.

Sheathing refers to the embedding of the fibres in a matrix, wherein sheathing can be done only at certain points or over a large area. Sheathing serves for solidifying the rovings relative to one another or, respectively, for fixing them on a substrate. Fixing can take place directly in the tool. For this purpose, heated dies can be used on a substrate by applying pressure for solidifying the rovings relative to one another or, respectively, for consolidating them. Alternative options for solidification are compressed air, suction via a vacuum or perhaps flexible hoses which lie in the channels and are inflated. Depending on the matrix material used, heating is necessary.

In a further variant, the process can be integrated directly into an injection moulding process, a pressing process, a thermoforming process or another manufacturing process. The positioned fibres are solidified directly in the process, for example, by filling the component contour with the injection moulding compound.

Sheathing can occur also outside of the tool. For this purpose, a flat gripper can grip the rovings oriented by the tool’s flow channels electrostatically, pneumatically, by means of negative pressure or by adhesion and can supply them to a sheathing station. There, a solidification of the rovings only relative to one another or a solidification of the rovings relative to one another and additionally on a substrate takes place.

All steps (providing a mold; introducing the continuous fibre or long fibre into the flow channel; positioning the continuous fibre or long fibre in the flow channel via a pressure gradient in the flow channel; and sheathing the continuous fibres or long fibres with a matrix) preferably take place in a mold.

The substrate itself can be a semi-finished product in the form of a film or plate. Films that ensure good adhesion to the matrix material are preferably used. The following can be mentioned by way of example: If a commingled yarn with a PP matrix is used, it is convenient to use a film or plate made of PP as the substrate. If a commingled yarn with a PA6 matrix is used, a metal plate with the appropriate bonding agent or a prepreg with a PA6 matrix can be used. Furthermore, the substrate can already be a three-dimensional structure, which is reinforced by the attachment of the fibres.

In a further aspect, the invention relates to a machining tool for the production of fibre composite materials, comprising a mold and at least one flow channel inserted into the mold, wherein at least one fluid nozzle is allocated to the flow channel, the fluid nozzle having a fibre reservoir for continuous fibres or long fibres.

The shape of the flow channels preferably has at least one curvature. The flow channel determines the flow direction and thus determines the orientation of the fibre strand in the semi-finished product or, respectively, component.

The mold is preferably composed of two tool halves, an upper part and a lower part. The flow channels can be incorporated into the lower part or the upper part or into the upper and lower parts. Only a single flow channel as well as several flow channels that are supplied with rovings can be incorporated into a tool.

In one embodiment variant, it is envisaged that the mold has two tool halves, with the flow channel being formed by both tool halves.

The contact surface between the tool halves can constitute a flat surface or can be curved in a complex fashion. If the contact surface is a flat surface, semi-finished products are preferably produced with the tool, which are to be reshaped and sheathed in a further step. If the reinforcement in a subsequent component is only two-dimensional, just a sheathing is required. If the contact surface is a curved surface, the degrees of deformation for a subsequent component can be reduced therewith, or the reinforcement geometry for the component could also be produced directly. In the latter case, just a sheathing is necessary.

Preferably, it is envisaged that the mold has a plurality of flow channels and the feeding occurs through one or several stationary nozzles. The nozzles move away only normally to the docking surface to provide the possibility of separating the fibres.

Steels, aluminium and other metals can be used as a material for the tool. Synthetic materials can also be a material for the tool. It is also possible that one of the two tool parts can be the substrate itself, which will be described later, or the flat gripper for removing the positioned rovings.

The cross-section of a channel can have any shape. Thus, it can be round, rectangular, or can have any other shape. The only criterion is that its cross-sectional area is equal to or - as preferred - larger than the cross-sectional area of the solid components of the roving.

In a further aspect, the invention relates to a machining tool for a plastics processing plant, comprising a mold and at least one flow channel inserted into the mold, wherein a fluid nozzle is allocated to the flow channel. Preferably, it is envisaged that the plastics processing plant is an injection moulding machine.

### DETAILED DESCRIPTION OF THE INVENTION

The invention is explained in further detail below, using examples and figures.

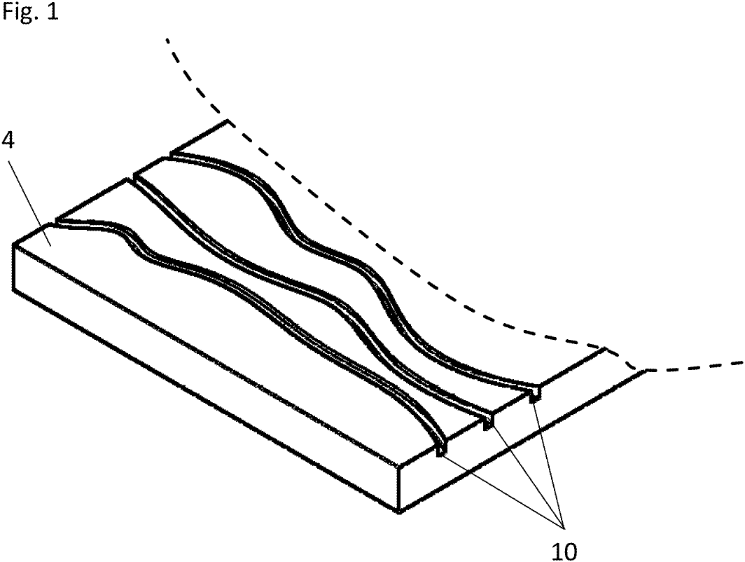

FIG. 1 schematically shows the lower part of a mold having flow channels.

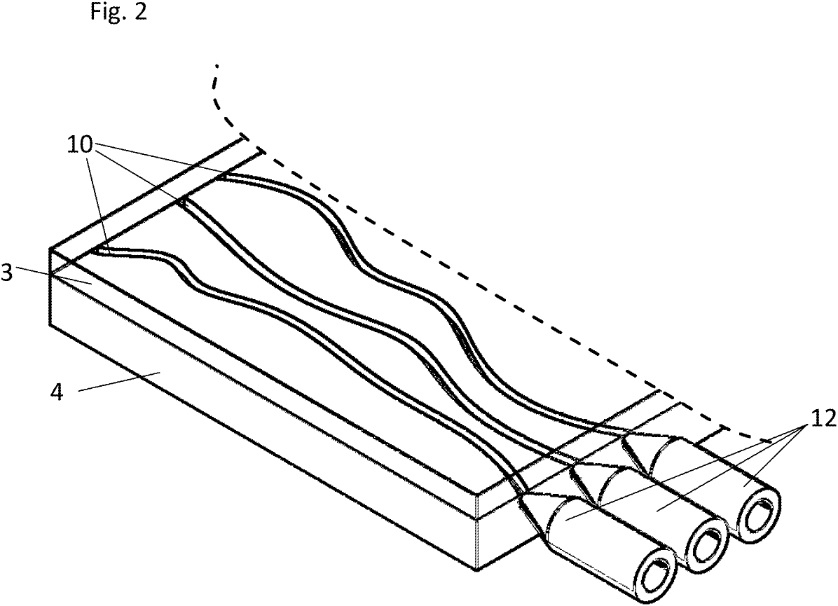

FIG. 2 schematically shows the lower part of a mold according to FIG. 1 with an upper part of the mold shown as transparent and the nozzles allocated to the flow channels.

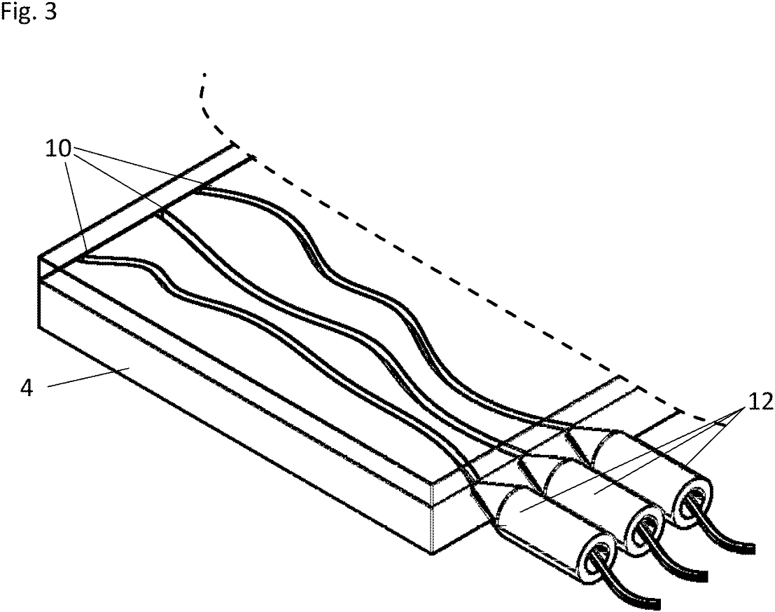

FIG. 3 shows the mold of FIG. 2 with nozzles and continuous fibres.

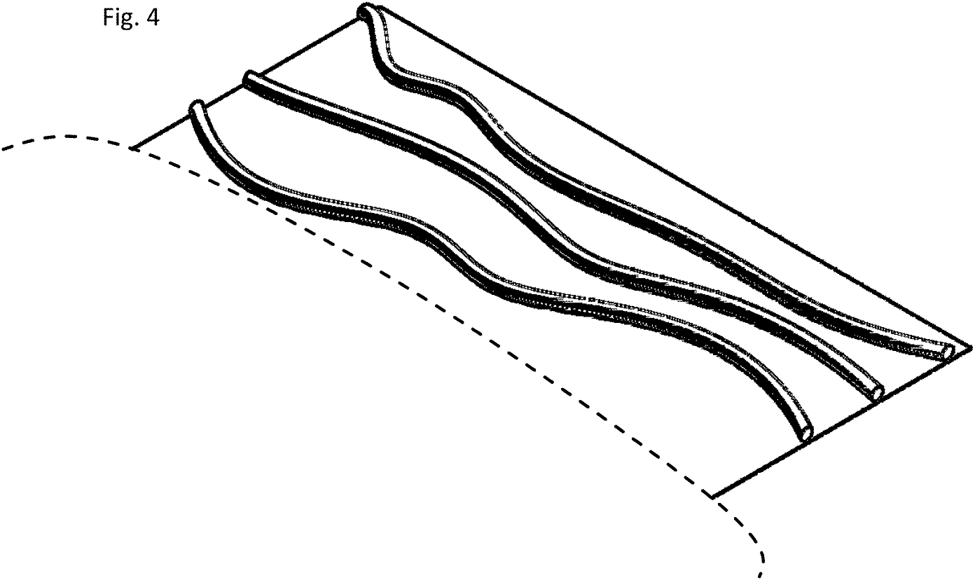

FIG. 4 shows a substrate with continuous fibres that have been deposited.

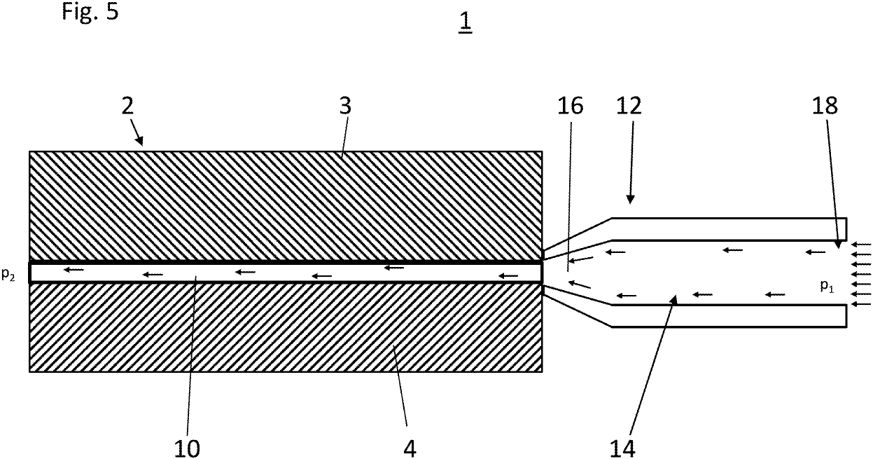

FIG. 5 schematically shows the entire structure of a machining tool according to the invention for a plastics processing plant.

The process according to the invention and the machining tool according to the invention are illustrated by way of the figures. Since the figures and the process steps are related, all figures are described jointly. In FIG. 3, the machining tool is shown. It includes a mold with two tool halves. The two tool halves form the flow channels.

As an example, a fluid nozzle 12 is allocated to each flow channel 10, the fluid nozzle having a fibre reservoir for continuous fibres.

For the process according to the invention for manufacturing a fibre-plastic composite with continuous fibres or long fibres, a mold with a tool half comprising at least one flow channel is initially provided. In the example of FIG. 1, three flow channels 10 are shown, which, in addition, are curved in different ways. The second tool half 3 is now positioned on the first tool half 4 and nozzles 12 are applied (FIG. 2). Subsequently, continuous fibres or long fibres are introduced into the flow channels via the nozzles. The continuous fibres are positioned in the flow channel via a pressure gradient (FIG. 3). The upper tool half can, for example, also be a plastic substrate so that the continuous fibres are fixed to the substrate by means of dies in the mold, for example.

The fibres used in the process are provided by nozzles. The fibre sections that are to be positioned in the tool are located in the nozzles in reservoirs tightly sealed against the environment. The channels are supplied through these nozzles. If the pressure gradient is generated, the nozzle and the tool, apart from inflow and outflow openings, are tightly sealed in order to generate the desired fluid stream in the tool channels. If the fibres are positioned in the tool, the nozzle withdraws from the tool and the rovings are severed between the tool and the nozzle. The separation can occur both mechanically and by removal (e.g., thermally).

The semi-finished products produced can be further processed by injection moulding. The semi-finished products can be functionalized in an already reshaped form by injection moulding, and any components as desired can be manufactured in this way.

In FIG. 5, the machining tool 1 according to the invention for performing the process is illustrated. It comprises a mold 2 with two tool halves 3, 4, an upper tool half 3 and a lower tool half 4. A flow channel 10 is inserted into the mold 2. This flow channel is formed in the lower tool half 4. A fluid nozzle 12 is allocated to the flow channel 10, the fluid nozzle 12 having a fibre reservoir 14 for continuous fibres 16 in the form of a roving. At the inlet 18 of the fluid nozzle 12, there is a pressure pi which is higher than the pressure p₂ in the flow channel 10. As a result of the pressure gradient Δp = pi - p₂ thus arising, the continuous fibre 16 is introduced into the flow channel 10.

1. A process for manufacturing a fibre-plastic composite with a secured fibre orientation, wherein continuous fibres (16) or long fibres are oriented and sheathed with a matrix, the process comprising the steps of:
a) providing a mold (2) comprising at least one flow channel (10),
b) introducing the continuous fibres (16) or long fibres into the at least one flow channel (10),
c) positioning and orienting the continuous fibres (10) or long fibres in the at least one flow channel (10) by way of a pressure gradient (Δp) in the flow channel (10),and
d) sheathing the continuous fibres (16) or long fibres with a matrix.

2. A process according to claim 1, wherein the continuous fibres (16) or long fibres are positioned in the flow channel (10) by a fluid stream.

3. A process according to claim 1 or claim 2, characterized in that securing of the fibre orientation occurs inside of the mold (2) or outside of the mold (2) on a carrier substrate.

4. A machining tool (1), comprising a mold (2) and at least one flow channel (10) inserted into the mold (2), wherein at least one fluid nozzle (12) is allocated to each flow channel (10), the fluid nozzle (12) having a fibre reservoir (14) for continuous fibres (16) or long fibres.

5. A machining tool according to claim 4, the mold (2) has two tool halves (3, 4), with the flow channel (10) being formed by both tool halves (3, 4).

6. A machining tool according to claim 4, wherein the at least one flow channel (10) dictates the orientation for continuous fibres (16) or long fibres from the fibre reservoir (14).

7. A machining tool according to claim 4, wherein the mold (2) has a plurality of flow channels (10).

8. A machining tool according to claim 4, wherein a pump is allocated to at least one flow channel (10).

9. A machining tool according to claim 7, wherein the fluid nozzle (12) has a moving unit and is movable from one flow channel (10) to the next flow channel (10).
